(19) United States
(12) Patent Application Publication
(10) Pub. No.: US 2012/0095120 A1
(43) Pub. Date: Apr. 19, 2012

(54) NOVEL THICKENING POLYMER IN THE FORM OF A POWDER

(75) Inventors: Olivier Braun, Castres (FR); Paul Mallo, Croissy-sur-Seine (FR)

(73) Assignee: SOCIETE D'EXPLOITATION DE PRODUITS POUR LES INDUSTRIES CHIMIQUES SEPPIC, Paris (FR)

(21) Appl. No.: 13/318,855

(22) PCT Filed: Mar. 30, 2010
(86) PCT No.: PCT/FR2010/050581

§ 371 Date: Nov. 4, 2011

(30) Foreign Application Priority Data
Mar. 31, 2009 (FR) 0952019

(51) Int. Cl. B01J 39/20

(52) U.S. Cl. 521/38

(57) ABSTRACT

Method for preparing an anionic polyelectrolyte including up to 95 mol % of monomer units from 2-methyl 2-[(1-oxo 2-propenyl) amino] 1-propanesulfonic acid that is totally salified in the form of sodium salt, up to 90 mol % of at least one neutral monomer, and optionally up to 10 mol % of at least one monomer of formula (I):

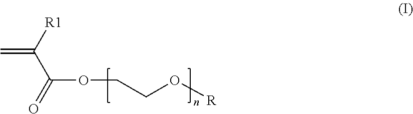

where: R1 is a hydrogen atom or a methyl radical, R is an alkyl radical, and n is a number greater than or equal to 1 and less than or equal to 50, the method including:
a) preparing a reaction mixture containing, in a solvent (S), 2-methyl 2-[(1-oxo 2-propenyl) amino] 1-propanesulfonic acid, the neutral monomer(s), the neutralizing agent, and optionally, the monomer(s) of formula (I); and
b) polymerizing the reaction mixture. The polyelectrolyte can be used as a thickening and/or stabilizing and/or emulsifying agent for a cosmetic, dermopharmaceutical or pharmaceutical topical composition.

The invention relates to novel polymers, to the method for preparing same and to the use thereof in cosmetic or pharmaceutical formulations.

The cosmetics industry very regularly uses synthetic thickening polymers for increasing the viscosity of creams, emulsions and various topical solutions.

The synthetic thickening polymers currently used in this industry are in two physical forms, the powder form and the liquid form in which the polymer is dispersed in a water-in-oil emulsion by means of surfactants. This liquid form is commonly called an inverse latex.

The thickening polymers in powder form used in this industry are mainly acrylic acid polymers or copolymers of acrylic acid and of alkyl acrylate, such as those sold under the names Carbopol™ and Pemulen™ and described in the United States patents published under numbers U.S. Pat. No. 5,373,044 and U.S. Pat. No. 2,798,053, or in the European patent application published under number EP 301 532.

More recently, 2-acrylamido-2-methylpropanesulfonic acid homopolymers or copolymers, also in the form of a powder, have also been used in this industry. Such products are sold under the name Aristoflex and described in the European patent applications published under numbers EP 816 403, EP 1 116 733 and EP 1 069 142.

All the polymers described above are obtained by precipitating polymerization, from the corresponding monomers dissolved in an organic solvent such as benzene, ethyl acetate, hexane, cyclohexane or tert-butanol.

These thickeners in the form of a powder make it possible to obtain clear gels and they are generally rather well-tolerated by the skin.

On the other hand, these thickeners in the form of a powder have certain drawbacks, in that they are sometimes difficult to handle, that they disperse or dissolve slowly in the medium to be thickened, that they often comprise a solvent residue and that their thickening capacity is considerably affected by the presence of electrolytes in the solution to be thickened.

The cosmetics industry also very widely uses thickeners in the form of inverse latexes, for example those sold under the names Sepigel™ 305, Simulgel™ 600, Simulgel™ EG, Simulgel™ NS, Simulgel™ A, Sepiplus™ 400, ™ 265 and Simulgel™ S.

Unlike the powdered polymers, the inverse latexes are easy to use and they disperse very readily, developing much better thickening performance levels.

Nevertheless, these inverse latexes have the drawback of containing an oil and one or more surfactants necessary for good stability of the product with respect to settling-out phenomena and good inversion properties required during use. As it happens, some of these oils and/or surfactants sometimes induce skin intolerance reactions. In addition, thickeners of this type do not make it possible to prepare clear gels.

The European patent application published under number EP 1 496 081 discloses powdered thickeners obtained from inverse latexes after removal of oil and spray-drying. A thickener of this type is sold under the name Sepinov™ EMT 10. Although they combine some of the advantages of conventional powdered thickeners, such as the lack of oil, and the advantages of inverse latexes, such as the high speed of dissolution in oil and a strong thickening capacity, they do not, however, produce completely clear gels and cannot therefore be used in the preparation of transparent cosmetic formulations. In addition, they do not have a satisfactory behavior in cosmetic compositions that are very rich in electrolytes, such as sunscreens.

It has been possible to improve the latter drawback, namely resistance to electrolytes, by synthesizing powdered polymers of ammonium 2-acrylamido-2-methylpropanesulfonate, of N,N-dimethylacrylamide and of pentacosaethoxylated (25 EO) behenyl methacrylate by precipitating polymerization in tert-butanol, such as those described in international application WO 2008/087326.

However, tert-butanol is an expensive solvent of which the purification, in particular the removal of the water formed during the polymerization process, is complex owing to the existence of an azeotrope.

Furthermore, the use of tert-butanol makes it necessary to neutralize the 2-acrylamido-2-methylpropanesulfonic acid with ammonia or with an ammonia-containing salt, since these are the only salts of this acid that are soluble in tert-butanol. However, the presence of ammonia remains a handicap in the cosmetics industry, whether it is a handicap of marketing type or technical type, such as the possible release of ammonia from the final formulation, or the possible side reactions of the ammonium ion with certain active ingredients, such as dihydroxyacetone (DHA), which is increasingly used in self-tanning formulations.

International application 00/38751 discloses a method for preparing ion-sensitive polymers which are insoluble in concentrated aqueous solutions and soluble in low salt solutions, by radical polymerization of monomers in free acid form, in an acetone/water (70/30 by weight) mixture, followed, after formation of the polymer, by optional neutralization of the polymer obtained.

Consequently, the inventors have sought to synthesize novel thickeners which do not have the drawbacks developed above.

A subject of the invention, according to a first aspect, is a method for preparing a linear, branched or crosslinked anionic polyelectrolyte, characterized in that said anionic polyelectrolyte comprises, for 100 mol %, up to 95 mol % of monomer units derived from 2-methyl-2-[(1-oxo-2-propenyl)amino]-1-propanesulfonic acid that is totally salified in the form of the sodium salt, up to 90 mol % of at least one neutral monomer, and optionally up to 10 mol % of at least one monomer of formula (I):

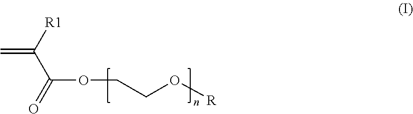

in which R1 is a hydrogen atom or a methyl radical, R is a linear or branched alkyl radical containing from eight to thirty carbon atoms, and n is a number greater than or equal to one and less than or equal to fifty, it being understood that the sum of the molar proportions of constituent monomer units of said anionic polyelectrolyte that are indicated above does not exceed 100 mol%, and in that said method comprises the following steps:
a step a) of preparing a reaction mixture containing, in the desired proportions and in a solvent (S), 2-methyl-2-[(1-oxo-2-propenyl)amino]-1-propanesulfonic acid, the neutral monomer(s), at least one neutralizing agent capable of forming the sodium salt of said 2-methyl-2-[(1-oxo-2-propenyl)amino]-1-propanesulfonic acid, if need be the monomer(s) of formula (I) as defined above, and, if necessary or if desired, crosslinking agent and/or other additives, said solvent (S) being:
either a ketone of formula (II):

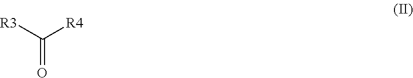

in which R3 and R4, which may be identical or different, are independently of one another a methyl radical, an ethyl radical, an isopropyl radical or an isobutyl radical;
or a mixture consisting of, for 100 mol %:
   water in a proportion greater than 0 mol % and less than or equal to 25 mol %; and
   a ketone of formula (II) as defined above, in a proportion greater than or equal to 75 mol % and less than 100 mol %;
a step b) during which the polymerization reaction is initiated by introducing, into said reaction mixture prepared in step a), a free-radical initiator and is then left to proceed to its conclusion, so as to obtain a precipitate of said linear, branched or crosslinked anionic polyelectrolyte.

The method as defined above may also comprise a step c) of isolating said precipitate obtained in step b) by separation from said solvent (S), and then if necessary or if desired, a step d) of drying said precipitate resulting from step c.

The term “branched polyelectrolyte” denotes a nonlinear polyelectrolyte which has pendant chains so as to obtain, when it is dissolved in water, a highly entangled state resulting in very high viscosities at low rate gradient.

The term “crosslinked polyelectrolyte” denotes a nonlinear polyelectrolyte which is in the form of a three-dimensional network that is water-insoluble but water-swellable and therefore results in the obtaining of a chemical gel.

The polyelectrolyte obtained by means of the method according to the invention can comprise crosslinked units and/or branched units.

In formula (I) as defined above, the expression “linear or branched alkyl radical containing from eight to thirty carbon atoms” denotes more particularly for R, either a radical derived from linear primary alcohols such as, for example, the octyl, decyl, undecyl, dodecyl, tridecyl, tetradecyl, pentadecyl, hexadecyl, heptadecyl, octadecyl, nonadecyl, eicosyl or docosyl or triacontanyl radical; or a radical derived from Guerbet alcohols, which are branched 1-alkanols corresponding to the general formula:

CH₃—(CH₂)ₚ—CH[CH₃—(CH₂)ₚ₋₂]—CH₂OH,

in which p is an integer between 2 and 14, such as, for example, 2-ethylhexyl, 2-propylheptyl, 2-butyloctyl, 2-pentylnonyl, 2-hexyldecyl or 2-octyldodecyl radicals; or a radical derived from isoalkanols corresponding to the general formula:

CH₃—CH(CH₃)—(CH₂)ₘ—CH₂OH,

in which m is an integer between 2 and 26, such as, for example, the 4-methylpentyl, 5-methylhexyl, 6-methylheptyl, 15-methylpentadecyl or 16-methylheptadecyl radicals, or the 2-hexyloctyl, 2-octyldecyl or 2-hexyldodecyl radicals.

The expression “at least one neutralizing agent capable of forming the sodium salt” denotes, in the method as defined above, in particular sodium carbonate, sodium hydroxide or sodium bicarbonate (also called sodium hydrogen carbonate).

According to one particular aspect of the method as defined above, the neutralizing agent is sodium bicarbonate.

According to another particular aspect of the present invention, the method as defined above is carried out in order to prepare an anionic polyelectrolyte comprising monomer units derived from the compound of formula (I) in which R is an alkyl radical containing from 10 to 22 carbon atoms, more particularly an alkyl radical containing from 12 to 22 carbon atoms and most particularly from 18 to 22 carbon atoms.

According to another particular aspect of the present invention, the method as defined above is carried out in order to prepare an anionic polyelectrolyte comprising monomer units derived from the compound of formula (I) in which n is an integer between 3 and 30.

According to another particular aspect of the present invention, the method as defined above is carried out in order to prepare an anionic polyelectrolyte comprising monomer units derived from the compound of formula (I) in which R1 is a hydrogen atom.

According to another particular aspect of the present invention, the method as defined above is carried out in order to prepare an anionic polyelectrolyte comprising monomer units derived from tetraethoxylated lauryl acrylate, from tetraethoxylated lauryl methacrylate, from pentacosaethoxylated behenyl acrylate or from pentacosaethoxylated behenyl methacrylate.

A subject of the invention, according to another particular aspect, is a method as defined above, in which said solvent (S) is:
either a ketone selected from propan-2-one, butan-2-one, pentan-2-one, 3-methylbutan-2-one, 3-ethylpentan-20-one or 4-methylpentan-2-one;
or a mixture consisting of, for 100 mol %:
   water in a proportion greater than 0 mol % and less than or equal to 10 mol %, preferably less than or equal to 5 mol %; and
   a ketone selected from propan-2-one, butan-2-one, pentan-2-one, 3-methylbutan-2-one, 3-ethylpentan-2-one or 4-methylpentan-2-one, of formula (II) as defined above, in a molar proportion greater than or equal to 90 mol %, preferably greater than or equal to 95 mol % and less than 100 mol %.

A subject of the invention, according to a most particular aspect, is the method as defined above, in which said solvent (S) is either acetone, or a water/acetone mixture in a water/acetone molar ratio greater than 0 and less than or equal to 5/95.

According to another particular aspect of the present invention, the method as defined above is characterized in that said anionic polyelectrolyte comprises no monomeric units derived from a compound of formula (I).

According to another particular aspect of the present invention, the method as defined above is characterized in that said anionic polyelectrolyte comprises, for 100 mol %, between 0.05 mol % and 5 mol %, and more particularly between 0.1 mol % and 1 mol %, of monomer units derived from a compound of formula (I), as defined above.

The neutral monomer is in particular selected from acrylamide, methacrylamide, N-alkylacrylamides, in which the alkyl group contains from one to four carbon atoms, for instance N-methylacrylamide, N-ethylacrylamide, N-propylacrylamide, N-isopropyl-acrylamide, N-butylacrylamide or N-(tert-butyl)acrylamide, N-alkylmethacrylamides, in which the alkyl group contains from one to four carbon atoms, for instance N-methylmethacrylamide, N-ethylmethacrylamide, N-propylmethacrylamide, N-isopropylmethacrylamide, N-butylmethacrylamide or N-(tert-butyl)methacrylamide, N,N-dialkylacrylamides, in which each of the alkyl groups contains between one and four carbon atoms, for instance N,N-dimethylacrylamide, N,N-diethylacrylamide or N,N-dipropylacrylamide, (2-hydroxyethyl) acrylate, (2,3-dihydroxypropyl) acrylate, (2-hydroxyethyl) methacrylate, (2,3-dihydroxypropyl) methacrylate, diacetone acrylamide or an ethoxylated derivative, having a molecular weight of between 400 g/mol and 1000 g/mol, of each of these esters, or vinylpyrrolidone.

According to another particular aspect of the present invention, the method as defined above is characterized in that said anionic polyelectrolyte comprises monomer units derived from a neutral monomer selected from acrylamide, (2-hydroxyethyl) acrylate or N,N-dimethylacrylamide.

According to one particular aspect of the present invention, the method as defined above is characterized in that said polyelectrolyte comprises, for 100 mol %, more than 10 mol %, preferably more than 25 mol % and up to 90 mol % of monomer units derived from 2-methyl-2-[(1-oxo-2-propenyl)amino]-1-propanesulfonic acid that is totally salified in the form of the sodium salt, from 5 mol % up to less than 90 mol %, preferably up to less than 75 mol %, of a neutral monomer, and from 0 mol % to 5 mol % of a monomer of formula (I) as defined above.

According to another particular aspect of the present invention, the method as defined above is characterized in that said anionic polyelectrolyte comprises, for 100 mol %, more than 50 mol %, preferably more than 75 mol % and up to 85 mol % of monomer units derived from 2-methyl-2-[(1-oxo-2-propenyl)amino]-1-propanesulfonic acid that is totally salified in the form of the sodium salt, from 10 mol % and up to less than 50 mol %, preferably less than 25 mol %, of a neutral monomer, and from 0 mol % to 5 mol % of a monomer of formula (I) as defined above.

According to another particular aspect of the present invention, the method as defined above is characterized in that said anionic polyelectrolyte is crosslinked and/or branched with a diethylene or polyethylene compound in the molar proportion, expressed relative to all the monomers used, of between 0.005 mol % and 1 mol %, and preferably from 0.01 mol % to 0.5 mol % and more particularly from 0.01 mol % to 0.25 mol %. According to this particular aspect, the crosslinking agent and/or the branching agent used is selected from ethylene glycol dimethacrylate, diallyloxacetic acid or a salt thereof such as sodium diallyloxyacetate, tetraallyloxyethane, ethylene glycol diacrylate, diallylurea, triallylamine, trimethylolpropane triacrylate, methylenebis(acrylamide) or a mixture of these compounds.

According to another aspect of the present invention, the method as defined above is carried out in order to prepare a crosslinked terpolymer of 2-methyl-2-[(1-oxo-2-propenyl)amino]-1-propanesulfonic acid that is salified in the form of the sodium salt, of N,N-dimethylacrylamide and of pentacosaethoxylated behenyl methacrylate, in which, for 100% of monomer units, more than 75 mol % and up to 85 mol % of monomer units are derived from 2-methyl-2-[(1-oxo-2-propenyl)amino]-1-propanesulfonic acid that is totally salified in the form of the sodium salt, from 10 mol % up to less than 25 mol % from a neutral monomer, and 0.05 mol % and 5 mol % from a monomer of formula (I).

A subject of the invention, according to another aspect, is also the terpolymer as defined above.

According to another particular aspect of the present invention, in step a) of the method as defined above, one or more additives selected from complexing agents, transfer agents and chain-limiting agents are added.

According to another particular aspect of the present invention, the method as defined above is carried out in order to prepare the following anionic polyelectrolytes:
copolymer of 2-methyl-2-[(1-oxo-2-propenyl)amino]-1-propanesulfonic acid that is partially salified in the form of the sodium salt and of acrylamide crosslinked with methylenebis(acrylamide);
copolymer of 2-methyl-2-[(1-oxo-2-propenyl)amino]-1-propanesulfonic acid that is partially salified in the form of the sodium salt and of acrylamide crosslinked with methylenebis(acrylamide);
copolymer of 2-methyl-2-[(1-oxo-2-propenyl)amino]-1-propanesulfonic acid that is partially salified in the form of the sodium salt and of N,N-dimethylacrylamide crosslinked with methylenebis(acrylamide);
terpolymer of 2-methyl-2-[(1-oxo-2-propenyl)amino]-1-propanesulfonic acid that is partially salified in the form of the sodium salt, of acrylamide and of tetraethoxylated lauryl acrylate, crosslinked with methylenebis(acrylamide);
terpolymer of 2-methyl-2-[(1-oxo-2-propenyl)amino]-1-propanesulfonic acid that is partially salified in the form of the sodium salt, of 2-hydroxyethyl acrylate and of tetraethoxylated lauryl acrylate, crosslinked with methylenebis(acrylamide);
terpolymer of 2-methyl-2-[(1-oxo-2-propenyl)amino]-1-propanesulfonic acid that is partially salified in the form of the sodium salt, of acrylamide and of pentacosaethoxylated behenyl methacrylate, crosslinked with methylenebis(acrylamide);
terpolymer of 2-methyl-2-[(1-oxo-2-propenyl)amino]-1-propanesulfonic acid that is partially salified in the form of the sodium salt, of 2-hydroxyethyl acrylate and of pentacosaethoxylated behenyl acrylate, crosslinked with trimethylolpropane triacrylate;
terpolymer of 2-methyl-2-[(1-oxo-2-propenyl)amino]-1-propanesulfonic acid that is partially salified in the form of the sodium salt, of acrylamide and of pentacosaethoxylated behenyl acrylate, crosslinked with methylenebis(acrylamide);
terpolymer of 2-methyl-2-[(1-oxo-2-propenyl)amino]-1-propanesulfonic acid that is partially salified in the form of the sodium salt, of N,N-dimethylacrylamide and of tetraethoxylated lauryl acrylate, crosslinked with methylenebis(acrylamide);
terpolymer of 2-methyl-2-[(1-oxo-2-propenyl)amino]-1-propanesulfonic acid that is partially salified in the form of the sodium salt, of N,N-dimethylacrylamide and of tetraethoxylated lauryl methacrylate, crosslinked with methylenebis(acrylamide);
terpolymer of 2-methyl-2-[(1-oxo-2-propenyl)amino]-1-propanesulfonic acid that is partially salified in the form of the sodium salt, of N,N-dimethylacrylamide and of pentacosaethoxylated behenyl methacrylate, crosslinked with methylenebis(acrylamide);
terpolymer of 2-methyl-2-[(1-oxo-2-propenyl)amino]-1-propanesulfonic acid that is partially salified in the form of the sodium salt, of N,N-dimethylacrylamide and of pentacosaethoxylated behenyl methacrylate, crosslinked with trimethylolpropane triacrylate.

According to another particular aspect of the present invention, in step b) of the method as defined above, the polymerization reaction is initiated at a temperature greater than or equal to 50° C. using a free-radical initiator that produces radicals by homolysis, such as dilauroyl peroxide, azobis(isobutyronitrile) or else azo derivatives.

According to another particular aspect of the present invention, in step b) of the method as defined above, the polymerization reaction is initiated by means of a redox couple, at a temperature less than or equal to 20° C., and then carried out in a quasiadiabatic manner.

According to another particular aspect of the present invention, in step c) of the method as defined above, the separation of the obtained precipitate from said organic solvent is carried out by filtration.

A subject of the invention is also a variant of the method as defined above, characterized in that it comprises, in place of step a), a step a2) of preparing a reaction mixture comprising, in the desired proportions and in a solvent (S), the neutral monomer(s), the sodium salt of said 2-methyl-2-[(1-oxo-2-propenyl)amino]-1-propanesulfonic acid, and if need be the monomer(s) of formula (I) as defined above, and more particularly a variant of the method as defined above, characterized in that it comprises, prior to step a2), a step a1) of preparing the sodium salt of 2-methyl-2-[(1-oxo-2-propenyl)amino]-1-propanesulfonic acid by neutralizing said 2-methyl-2-[(1-oxo-2-propenyl)amino]-1-propanesulfonic acid with a neutralizing agent capable of forming the sodium salt of said 2-methyl-2-[(1-oxo-2-propenyl)amino]-1-propanesulfonic acid.

A subject of the invention, according to another aspect, is the use of the anionic polyelectrolyte obtained by means of the method as defined above, or terpolymer as defined above, as thickener and/or as stabilizer and/or emulsifier for a cosmetic, dermopharmaceutical or pharmaceutical topical composition.

A subject of the invention, according to another aspect, is a cosmetic, dermopharmaceutical or pharmaceutical topical composition containing an effective amount of anionic polyelectrolyte obtained by means of the method as defined above or of the terpolymer as defined above.

The term “effective amount” is intended to mean an amount that is sufficient to obtain satisfactory thickening of said cosmetic, dermopharmaceutical or pharmaceutical topical composition.

According to another particular aspect of the present invention, said cosmetic, dermopharmaceutical or pharmaceutical topical composition contains between 0.1% and 10% by weight and more particularly from 0.5% to 5% by weight of the anionic polyelectrolyte obtained by means of the method as defined above or of the terpolymer as defined above.

A topical composition according to the invention, intended to be applied to the skin or the mucous membranes of humans or of animals, can consist of a topical emulsion comprising at least one aqueous phase and at least one oil phase. This topical emulsion may be of the oil-in-water (O/W), water-in-oil (W/O), oil-in-water-in-oil (O/W/O) or water-in-oil-in-water (W/O/W) type. The oil phase of the topical emulsion may consist of a mixture of one or more oils.

A topical composition according to the invention may be intended for cosmetic use or may be used to prepare a medicament intended for the treatment of diseases of the skin, of the scalp and of the mucous membranes. In the latter case, the topical composition then contains an active ingredient which may, for example, consist of an anti-inflammatory, a muscle relaxant, an antifungal agent, an antibacterial agent or an antidandruff agent.

When the topical composition is used as a cosmetic composition intended to be applied to the skin, the scalp or the mucous membranes, it can optionally contain an active ingredient, for example a moisturizing agent, a self-tanning agent, a sunscreen, an antiwrinkle agent, a slimming agent, a free-radical scavenger, an anti-acne agent, an antifungal agent or an antidandruff agent.

A subject of the invention, according to a final particular aspect, is a cosmetic topical composition, as defined above, also containing from 0.5% to 5% by weight of dihydroxyacetone.

The pH of the topical composition is preferably greater than or equal to 3.

The topical composition may also contain compounds that are conventionally included in compositions of this type, for example fragrances, preservatives, coloring agents, pigments, sunscreens, active ingredients, emollients or surfactants.

According to one particular aspect, the invention relates to the use of the anionic polyelectrolyte as defined above, for thickening, emulsifying and stabilizing a topical composition comprising at least one aqueous phase.

The anionic polyelectrolyte according to the invention is an advantageous substitute for the inverse latexes sold under the names Sepigel™ 305, Sepigel™ 501, Simulgel™ EG, Simulgel™ EPG, Simulgel™ NS, Simulgel™ 600, Simulgel™ A, Sepiplus™ 265, Sepiplus™ 250, Sepiplus™ 400 or Sepinov™ EMT 10 by the applicant, since it also exhibits good compatibility with the other excipients used for preparing formulations such as milks, lotions, creams, soaps, baths, balms, shampoos or conditioners. It can also be used with said Sepigel™ or Simulgel™, Sepiplus™ and/or Sepinov™ EMT 10.

It is in particular compatible with the concentrates described and claimed in international publications WO 92/06778, WO 95/04592, WO 95/13863, WO 96/37285, WO 98/22207 and WO 98/47610 or in FR 2 734 496, and with the surfactants described in WO 93/08204.

It is particularly compatible with Montanov™ 68, Montanov™ 82, Montanov™ 202, Montanov™ L, Montanov™ S, Fluidanov™ 20X or Easynov™. It can also be used in emulsions of the type of those described and claimed in EP 0 629 396 and in cosmetically or physiologically acceptable aqueous dispersions with an organopolysiloxane compound chosen, for example, from those described in WO 93/05762 or in WO 93/21316.

It can also be used for forming cosmetically or physiologically acceptable aqueous gels at acidic pH, such as those described in WO 93/07856; it can also be used in combination with nonionic celluloses, in order to form, for example, hairstyling gels such as those described in EP 0 684 024, or else in combination with fatty acid esters of a sugar, in order to form compositions for treating the hair or the skin, such as those described in EP 0 603 019, or else in the shampoos or conditioners as described and claimed in WO 92/21316 or, finally, in combination with an anionic homopolymer, such as Carbopol™, in order to form hair treatment products such as those described in DE 19523596.

The polyelectrolyte according to the invention is also compatible with active ingredients such as, for example, self-tanning agents, for instance dihydroxyacetone (DHA), erythrulose or anti-acne agents; it can therefore be introduced into self-tanning compositions such as those claimed in EP 0 715 845, EP 0 604 249 or EP 0 576 188, or in WO 93/07902.

It is also compatible with N-acyl derivatives of amino acids, which allows it to be used in soothing compositions in particular for sensitive skin, such as those described or claimed in WO 92/21318, WO 94/27561 or WO 98/09611.

It is also compatible with thickening and/or gelling polymers, such as hydrocolloids of plant or biosynthetic origin, for example xanthan gum, karaya gum, carrageenates, alginates, galactomannans; such as silicates; such as cellulose and derivatives thereof; such as starch and hydrophilic derivatives thereof; such as polyurethanes.

The following examples illustrate the invention without, however, limiting it.

### A) TERPOLYMER OF ATBS (NA SALT/DMAM/BEM 25) CROSSLINKED WITH TRIMETHYLOLPROPANE TRIACRYLATE ACCORDING TO THE METHOD WHICH IS THE SUBJECT OF THE INVENTION (POLYELECTROLYTE 1)

1) The following are charged to a 2-liter glass reactor at 20° C.:
344 g of acetone,
50.8 g of 2-acrylamido-2-methylpropanesulfonic acid (ATBS G)
20.8 g of NaHCO₃
6.1 g of N,N-dimethylacrylamide
9.6 g of deionized water
0.58 g of pentacosaethoxylated behenyl methacrylate (BEM-25)
0.45 g of trimethylolpropane triacrylate. 2) The reactor is stirred and then vigorous nitrogen sparging is applied for 1 h. The reaction medium is then heated to 55° C. and then 0.75 g of dilauroyl peroxide is added in order to initiate the polymerization.

The medium rapidly thickens and then becomes more fluid again after 30 min.

3) After two hours of maintaining at the reflux of acetone, the reaction medium is cooled.

4) After filtration, the polyelectroyle (1) powder collected is dried in an oven under vacuum.

Evaluation of the Properties of the Polymer Obtained

Viscosity at 25° C. of the solution of powder at 2% in water (Brookfield RVT, spindle 6, speed 5): η=60 200 mPa.s.

Viscosity at 25° C. of the solution of powder at 2% in water+0.1% NaCl (Brookfield RVT, spindle 6, speed 5): η=71 000 mPa.s.

Viscosity at 25° C. of the solution of powder at 2% in water+1% NaCl (Brookfield RVT, spindle 6, speed 5): η=60 200 mPa.s.

One attempt that consisted in reproducing step 1) of paragraph A) above, in order to prepare a solution containing sodium 2-acrylamido-2-methylpropanesulfonate at 15.5% by weight in a tert-butanol/water mixture (97.5/2.5 vol/vol) ended in failure, the sodium salt of 2-acrylamido-2-methylpropanesulfonic acid tending to form a precipitate and/or an unstable dispersion in the tert-butanol, rendering impossible a homogeneous polymerization with the other monomers soluble for this solvent.

### B) EXAMPLES OF FORMULATIONS PREPARED WITH POLYELECTROLYTE 1 PREPARED BY MEANS OF THE METHOD ACCORDING TO THE INVENTION

### Example 1: Care Cream

| | |
|---|---|
| Cyclomethicone: | 10% |
| Polyelectrolyte 1: | 0.8% |
| Montanov ™ 68: | 2% |
| Stearyl alcohol: | 1% |
| Stearic alcohol: | 0.5% |
| Preservative: | 0.65% |
| Lysine: | 0.025% |
| EDTA (disodium salt): | 0.05% |
| Xanthan gum: | 0.2% |
| Glycerol: | 3% |
| Water: | q.s. 100% |

### Example 2: Aftershave Balm

| FORMULA | | |
|---|---|---|
| A | Polyelectrolyte 1: | 1.5% |
| | Water: | q.s. 100% |
| B | Micropearl ™ M 100: | 5.0% |
| | Sepicide ™ CI: | 0.50% |
| | Fragrance: | 0.20% |
| | 95° ethanol: | 10.0% |

PROCEDURE: B is added to A.

### Example 3: Satin Body Emulsion

| FORMULA | | |
|---|---|---|
| A | Simulsol ™ 165: | 5.0% |
| | Lanol ™ 1688: | 8.50% |
| | Shea butter: | 2% |
| | Paraffin oil: | 6.5% |
| | Lanol ™ 14M: | 3% |
| | Lanol ™ S: | 0.6% |
| B | Water: | 66.2% |
| C | Micropearl ™ M 100: | 5% |
| D | Polyelectrolyte 1: | 3% |
| E | Sepicide ™ CI: | 0.3% |
| | Sepicide ™ HB: | 0.5% |
| | Aquaxyl ™: | 3% |
| | Fragrance: | 0.20% |
| | Vitamin E acetate: | 0.20% |
| | Sodium pyrrolidinonecarboxylate: | 1% |

PROCEDURE: C is added to B, B is emulsified in A at 70° C., and then D is added at 60° C. followed by E at 30° C.

### Example 4: O/W Cream

| FORMULA | | |
|---|---|---|
| A | Simulsol ™ 165: | 5.0% |
| | Lanol ™ 1688: | 20.0% |
| | Lanol ™ P: | 1.0% |
| B | Water: | q.s. 100% |
| C | Polyelectrolyte 1: | 2.50% |
| D | Sepicide ™ CI: | 0.20% |
| | Sepicide ™ HB: | 0.30% |

PROCEDURE: B is introduced into A at around 75° C.; C is added at around 60° C., followed by D at around 45° C.

### Example 5: Nongreasy Antisun Gel

| FORMULA | | |
|---|---|---|
| A | Polyelectrolyte 1: | 3.00% |
| | Water: | 30% |
| B | Sepicide ™ CI: | 0.20% |
| | Sepicide ™ HB: | 0.30% |
| | Fragrance: | 0.10% |
| C | Coloring agent: | q.s. |
| | Water: | 30% |
| D | Micropearl ™ M 100: | 3.00% |
| | Water: | q.s. 100% |
| E | Silicone oil: | 2.0% |
| | Parsol ™ MCX: | 5.00% |

PROCEDURE B is introduced into A; C is added, followed by D and then E.

### Example 6: Antisun Milk

| FORMULA | | |
|---|---|---|
| A | Montanov ™ S: | 3.0% |
| | Sesame oil: | 5.0% |
| | Parsol ™ MCX: | 5.0% |
| | λ carrageenan: | 0.10% |
| B | Water: | q.s. 100% |
| C | Polyelectrolyte 1: | 0.80% |
| D | Fragrance: | q.s. |
| | Preservative: | q.s. |

PROCEDURE: B is emulsified in A at 75° C. and then C is added at around 60° C., followed by D at around 30° C., and the pH is adjusted if necessary.

### Example 7: Massage Gel

| FORMULA | | |
|---|---|---|
| A | Polyelectrolyte 1: | 3.5% |
| | Water: | 20.0% |
| B | Coloring agent: | 2 drops/100 g |
| | Water: | q.s. |
| C | Ethanol: | 10% |
| | Menthol: | 0.10% |
| D | Silicone oil: | 5.0% |

PROCEDURE: B is added to A, and then C is added to the mixture, followed by D.

### Example 8: Moisturizing and Matting Foundation

| FORMULA | | |
|---|---|---|
| A | Water: | 20.0% |
| | Butylene glycol: | 4.0% |
| | PEG-400: | 4.0% |
| | Pecosil ™ PS100: | 1.0% |
| | Sodium hydroxide: | q.s. pH = 9 |
| | Titanium hydroxide: | 7.0% |
| | Talc: | 2.0% |
| | Yellow iron oxide: | 0.8% |
| | Red iron oxide: | 0.3% |
| | Black iron oxide: | 0.05% |
| B | Lanol ™ 99: | 8% |
| | Caprylic capric triglyceride: | 8% |
| | Montanov ™ 202: | 5.00% |
| C | Water: | q.s. 100% |
| | Micropearl ™ M305: | 2.0% |
| | Tetrasodium EDTA: | 0.05% |
| D | Cyclomethicone: | 4.0% |
| | Xanthan gum: | 0.2% |
| | Polyelectrolyte 1: | 0.8% |
| E | Sepicide ™ HB: | 0.5% |
| | Sepicide CI: | 0.3% |
| | Fragrance: | 0.2% |

PROCEDURE: The mixtures B + D and A + C are prepared at 80° C., and are then mixed and emulsified together.

### Example 9: Radiance Gel

| | | |
|---|---|---|
| A | Polyelectrolyte 1: | 4% |
| | Water: | 30% |
| B | Elastine HPM: | 5.0% |
| C | Micropearl ™ M 100: | 3% |
| | Water: | 5% |
| D | Sepicide ™ CI: | 0.2% |
| | Sepicide ™ HB: | 0.3% |
| | Fragrance: | 0.06% |
| | 50% sodium pyrrolidinonecarboxylate: | 1% |
| | Water: | q.s. 100% |

PROCEDURE: A is prepared; B is added, followed by C and then D.

### Example 10: Body Milk

| | |
|---|---|
| Montanov ™ S: | 3.5% |
| Lanol ™ 37T: | 8.0% |
| Solagum ™ L: | 0.05% |
| Water: | q.s. 100% |
| Benzophenone-3: | 2.0% |
| Dimethicone 350 cPs: | 0.05% |
| Polyelectrolyte 1: | 0.8% |
| Preservative: | 0.2% |
| Fragrance: | 0.4% |

### Example 11: Makeup-Removing Emulsion with Sweet Almond Oil

| | |
|---|---|
| Montanov ™ 68: | 5% |
| Sweet almond oil: | 5% |
| Water: | q.s. 100% |
| Polyelectrolyte 1: | 0.3% |
| Glycerol: | 5% |
| Preservative: | 0.2% |
| Fragrance: | 0.3% |

### Example 12: Moisturizing Cream for Greasy Skin

| | |
|---|---|
| Montanov ™ 68: | 5% |
| Cetylstearyl octanoate: | 8% |
| Octyl palmitate: | 2% |
| Water: | q.s. 100% |
| Polyelectrolyte 1: | 0.6% |
| Micropearl ™ M100: | 3.0% |
| Mucopolysaccharides: | 5% |
| Sepicide ™ HB: | 0.8% |
| Fragrance: | 0.3% |

### Example 13: Alcohol-Free Soothing Aftershave Balm

| | |
|---|---|
| Lipacide ™ PVB: | 1.0% |
| Lanol ™ 99: | 2.0% |
| Sweet almond oil: | 0.5% |
| Polyelectrolyte 1: | 3.5% |
| Water: | q.s. 100% |
| Fragrance: | 0.4% |
| Sepicide ™ HB: | 0.4% |
| Sepicide ™ CI: | 0.2% |

### Example 14: Cream with AHAs for Sensitive Skin

| Mixture of N-lauroyl amino acids: | 0.1% to 5% |
|---|---|
| Magnesium potassium aspartate: | 0.002% to 0.5% |
| Lanol ™ 99: | 2% |
| Montanov ™ 68: | 5.0% |
| Water: | q.s. 100% |
| Polyelectrolyte 1: | 1.50% |
| Gluconic acid: | 1.50% |
| Triethanolamine (TEA): | 0.9% |
| Sepicide ™ HB: | 0.3% |
| Sepicide ™ CI: | 0.2% |
| Fragrance: | 0.4% |

### Example 15: Soothing Aftersun Care Product

| Mixture of N-lauryl amino acids: | 0.1% to 5% |
|---|---|
| Magnesium potassium aspartate: | 0.002% to 0.5% |
| Lanol ™ 99: | 10.0% |
| Water: | q.s. 100% |
| Polyelectrolyte 1: | 2.50% |
| Sepicide ™ HB: | 0.3% |
| Sepicide ™ CI: | 0.2% |
| Fragrance: | 0.4% |
| Coloring agent: | 0.03% |

### Example 16: Make-up Removing Milk

| | |
|---|---|
| Montanov ™ S: | 3% |
| PRIMOL ™ 352: | 8.0% |
| Sweet almond oil: | 2% |
| Water: | q.s. 100% |
| Polyelectrolyte 1: | 0.8% |
| Preservative: | 0.2% |

### Example 17: Fluid Emulsion at Alkaline pH

| | |
|---|---|
| Marcol ™ 82: | 5.0% |
| Sodium hydroxide: | 10.0% |
| Water: | q.s. 100% |
| Polyelectrolyte 1: | 1.5% |

### Example 18: Fluid Foundation

| | |
|---|---|
| Simulsol ™ 165: | 5.0% |
| Lanol ™ 84D: | 8.0% |
| Lanol ™ 99: | 5.0% |
| Water: | q.s. 100% |
| Mineral pigments and fillers: | 10.0% |
| Polyelectrolyte 1: | 1.2% |
| Preservative: | 0.2% |
| Fragrance: | 0.4% |

### Example 19: Antisun Milk

| | |
|---|---|
| Montanov ™ S: | 3.5% |
| Lanol ™ 37T: | 10.0% |
| Parsol ™ MCX: | 5.0% |
| Eusolex ™ 4360: | 2.0% |
| Water: | q.s. 100% |
| Polyelectrolyte 1: | 1.8% |
| Preservative: | 0.2% |
| Fragrance: | 0.4% |

### Example 20: Gel for Around the Eyes

| | |
|---|---|
| Polyelectrolyte 1: | 2.0% |
| Fragrance: | 0.06% |
| Sodium pyrrolidinonecarboxylate: | 0.2% |
| Dow Corning ™ 245 Fluid: | 2.0% |
| Water: | q.s. 100% |

### Example 21: Leave-on Care Composition

| | |
|---|---|
| Polyelectrolyte 1: | 1.5% |
| Fragrance: | q.s. |
| Preservative: | q.s. |
| Dow Corning ™ X2 8360: | 5.0% |
| Dow Corning ™ Q2 1401: | 15.0% |
| Water: | q.s. 100% |

### Example 22: Slimming Gel

| | |
|---|---|
| Polyelectrolyte 1: | 5% |
| Ethanol: | 30% |
| Menthol: | 0.1% |
| Caffeine: | 2.5% |
| Extract of ruscus: | 2% |
| Extract of ivy: | 2% |
| Sepicide ™ HB: | 1% |
| Water: | q.s. 100% |

### Example 23: Ultra-Natural Tinted Cream Gel

| FORMULA | | |
|---|---|---|
| A | Water: | 10.0% |
| | Butylene glycol: | 4.0% |
| | PEG-400: | 4.0% |
| | Pecosil ™ PS100: | 1.5% |
| | NaOH: | q.s. pH = 7 |
| | Titanium dioxide: | 2.0% |
| | Yellow iron oxide: | 0.8% |
| | Red iron oxide: | 0.3% |
| | Black iron oxide: | 0.05% |
| B | Lanol ™ 99: | 4.0% |
| | Caprylic capric triglyceride | 4.0% |
| | Sepifeel ™ ONE: | 1.0% |
| | Polyelectrolyte 1: | 3.0% |
| C | Water: | q.s. 100% |
| | Micropearl ™ M305: | 2.0% |
| | Tetrasodium EDTA: | 0.05% |
| | Cyclomethicone: | 4.0% |
| D | Sepicide ™ HB: | 0.5% |
| | Sepicide CI: | 0.3% |
| | Fragrance: | 0.2% |

PROCEDURE: The mixture B + C is prepared and then A is added followed by D.

### Example 24: Care Product for Greasy Skin

| | |
|---|---|
| Micropearl ™ M310: | 1.0% |
| Polyelectrolyte 1: | 5.0% |
| Octyl isononanoate: | 4.0% |
| Water: | q.s. 100% |
| Sepicontrol ™ A5: | 4.0% |
| Fragrance: | 0.1% |
| Sepicide ™ HB: | 0.3% |
| Sepicide ™ CI: | 0.2% |
| Capigel ™ 98: | 0.5% |
| Water: | 10% |

### Example 25: Cream with AHAs

| | |
|---|---|
| Montanov ™ 68: | 5.0% |
| Lipacide ™ PVB: | 1.05% |
| Lanol ™ 99: | 10.0% |
| Water: | q.s. 100% |
| Gluconic acid: | 1.5% |
| TEA (triethanolamine): | 0.9% |
| Polyelectrolyte 1: | 1.5% |
| Fragrance: | 0.4% |
| Sepicide ™ HB: | 0.2% |
| Sepicide ™ CI: | 0.4% |

### Example 26: Nongreasy Self-Tanning Product for the Face and the Body

| | |
|---|---|
| Lanol ™ 2681: | 3.0% |
| Polyelectrolyte 1: | 2.5% |
| Water: | q.s. 100% |
| Dihydroxyacetone: | 3.0% |
| Fragrance: | 0.2% |
| Sepicide ™ HB: | 0.8% |
| Sodium hydroxide: | q.s. pH = 5 |

### Example 27: Antisun Milk with Monoi de Tahiti Oil

| | |
|---|---|
| Monoi de Tahiti oil: | 10% |
| Lipacide ™ PVB: | 0.5% |
| Polyelectrolyte 1: | 2.2% |
| Water: | q.s. 100% |
| Fragrance: | 0.1% |
| Sepicide ™ HB: | 0.3% |
| Sepicide ™ CI: | 0.1% |
| Parsol ™ MCX: | 4.0% |

### Example 28: Facial Antisun Care Product

| | |
|---|---|
| Cyclomethicone and dimethiconol: | 4.0% |
| Polyelectrolyte 1: | 3.5% |
| Water: | q.s. 100% |
| Fragrance: | 0.1% |
| Sepicide ™ HB: | 0.3% |
| Sepicide ™ CI: | 0.21% |
| PARSOL ™ MCX: | 5.0% |
| Titanium mica: | 2.0% |
| Lactic acid: | q.s. pH = 6.5 |

### Example 29: No-Sun Tanning Emulsion

| | |
|---|---|
| Lanol ™ 99: | 15% |
| Montanov ™ 68: | 5.0% |
| Parsol ™ MCX: | 3.0% |
| Water: | q.s. 100% |
| Dihydroxyacetone: | 5.0% |
| Monosodium phosphate: | 0.2% |
| Polyelectrolyte 1: | 0.5% |
| Fragrance: | 0.3% |
| Sepicide ™ HB: | 0.8% |
| Sodium hydroxide: | q.s. pH = 5 |

### Example 30: Care Cream

| | |
|---|---|
| Cyclomethicone: | 10% |
| Polyelectrolyte 1: | 0.8% |
| Montanov ™ 68: | 4.5% |
| Preservative: | 0.65% |
| Lysine: | 0.025% |
| EDTA (disodium salt): | 0.05% |
| Xanthan gum: | 0.2% |
| Glycerol: | 3% |
| Water: | q.s. 100% |

### Example 31: Care Cream

| | |
|---|---|
| Cyclomethicone: | 10% |
| Polyelectrolyte 2: | 0.8% |
| Montanov ™ 68: | 4.5% |
| Polyfluoropropylmethyl isopropyl ether: | 0.5% |
| Preservative: | 0.65% |
| Lysine: | 0.025% |
| EDTA (disodium salt): | 0.05% |
| Pemulen ™ TR1: | 0.2% |
| Glycerol: | 3% |
| Water: | q.s. 100% |

### Example 32: Body Milk

| FORMULA | | |
|---|---|---|
| A | Simulsol ™ 165: | 5.0% |
| | Lanol ™ 1688: | 12.0% |
| | Lanol ™ 14 M: | 2.0% |
| | Cetyl alcohol: | 0.3% |
| | Schercemol ™ OP: | 3% |
| B | Water: | q.s. 100% |
| C | Polyelectrolyte 1: | 0.35% |
| D | Sepicide ™ CI: | 0.2% |
| | Sepicide ™ HB: | 0.5% |
| | Fragrance: | 0.20% |

PROCEDURE: B is emulsified in A at around 75° C.; C is added at around 60° C., followed by D at around 30° C.

### Example 33: Massage Care Gel

| FORMULA | | |
|---|---|---|
| A | Polyelectrolyte 1: | 3.00% |
| | Water: | 30% |
| B | Sepicide ™ CI: | 0.20% |
| | Sepicide ™ HB: | 0.30% |
| | Fragrance: | 0.05% |
| C | Coloring agent: | q.s. |
| | Water: | q.s. 100% |
| D | Micropearl ™ SQL: | 5.0% |
| | Lanol ™ 1688: | 2% |

PROCEDURE: A is prepared; B is added, followed by C and then D.

### Example 34: Body Milk

| FORMULA | | |
|---|---|---|
| A | Montanov ™ S: | 3.0% |
| | Glyceryl triheptonate: | 10.0% |
| B | Water: | q.s. 100% |
| C | Polyelectrolyte 1: | 1.0% |
| D | Fragrance: | q.s. |
| | Preservative: | q.s. |

PROCEDURE: A is melted at approximately 75° C. B is emulsified in A at 75° C. and then C is added at around 60° C., followed by D.

### Example 35: Alcohol-Free Soothing Aftershave Balm

| Mixture of lauryl amino acids: | 0.1% to 5% |
|---|---|
| Magnesium potassium aspartate: | 0.002% to 0.5% |
| Lanol ™ 99: | 2% |
| Sweet almond oil: | 0.5% |
| Water: | q.s. 100% |
| Polyelectrolyte 1: | 3% |
| Sepicide ™ HB: | 0.3% |
| Sepicide ™ CI: | 0.2% |
| Fragrance: | 0.4% |

### Example 36: Body Milk

| | |
|---|---|
| Montanov ™ S: | 3.5% |
| Lanol ™ 37T: | 8.0% |
| Solagum ™ L: | 0.05% |
| Water: | q.s. 100% |
| Benzophenone-1: | 2.0% |
| Dimethicone 350 cPs: | 0.05% |
| Polyelectrolyte 2: | 0.8% |
| Preservative: | 0.2% |
| Fragrance: | 0.4% |

### Example 37: Alcohol-free soothing aftershave balm

| | |
|---|---|
| Lipacide ™ PVB: | 1.0% |
| Lanol ™ 99: | 2.0% |
| Sweet almond oil: | 0.5% |
| Polyelectrolyte 1: | 3.5% |
| Water: | q.s. 100% |
| Fragrance: | 0.4% |
| Sepicide ™ HB: | 0.4% |
| Sepicide ™ CI: | 0.2% |

### Example 38: Refreshing Aftershave Gel

| | |
|---|---|
| Lipacide ™ PVB: | 0.5% |
| Lanol ™ 99: | 5.0% |
| Polyelectrolyte 1: | 2.5% |
| Water: | q.s. 100% |
| Micropearl ™ LM: | 0.5% |
| Fragrance: | 0.2% |
| Sepicide ™ HB: | 0.3% |
| Sepicide ™ CI: | 0.2% |

### Example 39: Cream with AHAs

| | |
|---|---|
| Montanov ™ 68: | 5.0% |
| Lipacide ™ PVB: | 1.05% |
| Lanol ™ 99: | 10.0% |
| Water: | q.s. 100% |
| Gluconic acid: | 1.5% |
| TEA (triethanolamine): | 0.9% |
| Polyelectrolyte 1: | 1.5% |
| Fragrance: | 0.4% |
| Sepicide ™ HB: | 0.2% |
| Sepicide ™ CI: | 0.4% |

### Example 40: Gloss Gel

| | |
|---|---|
| Polyelectrolyte 1: | 1.5% |
| Volatile silicone: | 25% |
| Monopropylene glycol: | 25% |
| Demineralized water: | 10% |
| Glycerol: | q.s. 100% |

### Example 41: Slimming Gel

| | |
|---|---|
| Polyelectrolyte 1: | 1.5% |
| Isononyl isononanoate: | 2% |
| Caffeine: | 5% |
| Ethanol: | 40% |
| Micropearl ™ LM: | 2% |
| Demineralized water: | q.s. 100% |
| Preservative fragrance: | q.s. |

### Example 42: Makeup-Removing Milk

| | |
|---|---|
| Simulsol ™ 165: | 4% |
| Montanov ™ 202: | 1% |
| Caprylate-caprate triglyceride: | 15% |
| Pecosil ™ DCT: | 1% |
| Demineralized water: | q.s. |
| Capigel ™ 98: | 0.5% |
| Polyelectrolyte 1: | 1% |
| Proteol ™ APL: | 2% |
| Sodium hydroxide: | q.s. pH = 7 |

### Example 43: Restructuring “Rinse-Off” Cream Mask for Stressed and Embrittled Hair

| | |
|---|---|
| Ketrol ™ T: | 0.5% |
| Pecosil ™ SPP50: | 0.75% |
| N-Cocoyl amino acids: | 0.70% |
| Butylene glycol: | 3.0% |
| Polyelectrolyte 1: | 3.0% |
| Montanov ™ 82: | 3.0% |
| Jojoba oil: | 1.0% |
| Lanol ™ P: | 6.0% |
| Amonyl ™ DM: | 1.0% |
| Lanol ™ 99: | 5.0% |
| Sepicide ™ HB: | 0.3% |
| Sepicide ™ CI: | 0.2% |
| Fragrance: | 0.2% |
| Water: | q.s. 100% |

### Example 44: Antisun Cream

| | |
|---|---|
| Simulsol ™ 165: | 3% |
| Montanov ™ 202: | 2% |
| C12-C15 benzoate: | 8% |
| Pecosil ™ PS 100: | 2% |
| Dimethicone: | 2% |
| Cyclomethicone: | 5% |
| Octyl para-methoxycinnamate: | 6% |
| Benzophenone-3: | 4% |
| Titanium oxide: | 8% |
| Xanthan gum: | 0.2% |
| Butylene glycol: | 5% |
| Demineralized water: | q.s. 100% |
| Polyelectrolyte 1: | 1.5% |
| Preservative, fragrance: | q.s. |

### Example 45: Care Gel for Combination Skin

| | |
|---|---|
| Polyelectrolyte 1: | 4% |
| Plant squalane: | 5% |
| Dimethicone: | 1.5% |
| Sepicontrol ™ A5: | 4% |
| Xanthan gum: | 0.3% |
| Water: | q.s. 100% |
| Preservative, fragrance: | q.s. |

### Example 46: Hair Lotion

| | |
|---|---|
| Butylene glycol: | 3.0% |
| Polyelectrolyte 1: | 3% |
| Simulsol ™ 1293: | 3.0% |
| Lactic acid: | q.s. pH = 6 |
| Sepicide ™ HB: | 0.2% |
| Sepicide ™ CI: | 0.3% |
| Fragrance: | 0.3% |
| Water: | q.s. 100% |

### Example 47: Protective, Relaxing Shampoo

| | |
|---|---|
| Amonyl ™ 675 SB: | 5.0% |
| 28% sodium lauryl ether sulfate: | 35.0% |
| Polyelectrolyte 1: | 3.0% |
| Sepicide ™ HB: | 0.5% |
| Sepicide ™ CI: | 0.3% |
| Sodium hydroxide: | q.s. pH = 7.2 |
| Fragrance: | 0.3% |
| Coloring agent (FDC blue 1/yellow 5): | q.s. |
| Water: | QS 100% |

### Example 48: “Leave-On” Protective Product; Antistress Haircare

| | |
|---|---|
| Ketrol ™ T: | 0.5% |
| Mixture of cocoyl amino acids: | 3.0% |
| Butylene glycol: | 5.0% |
| DC 1501: | 5.0% |
| Polyelectrolyte 1: | 4.0% |
| Sepicide ™ HB: | 0.5% |
| Sepicide ™ CI: | 0.3% |
| Fragrance: | 0.3% |
| Water: | QS 100 |

### Example 49: Cream with Vitamins

| | |
|---|---|
| Simulsol ™ 165: | 5% |
| Montanov ™ 202: | 1% |
| Caprylic/capric triglycerides: | 20% |
| Vitamin A palmitate: | 0.2% |
| Vitamin E acetate: | 1% |
| Micropearl ™ M 305: | 1.5% |
| Polyelectrolyte 1: | 2% |
| Water: | q.s. 100% |
| Preservative, fragrance: | q.s. |

### Example 50: Antisun Gel

| | |
|---|---|
| Polyelectrolyte 1: | 3.00% |
| Sepicide ™ CI: | 0.20% |
| Sepicide ™ HB: | 0.30% |
| Fragrance: | 0.10% |
| Coloring agent: | q.s. |
| Silica: | 3.00% |
| Water: | q.s. 100% |
| Silicone oil: | 2.0% |
| Benzophenone-3: | 5.00% |

### Example 51: Lip Gloss

| | |
|---|---|
| Polyelectrolyte 1: | 1.50% |
| Schercemol ™ TISC: | 15.00% |
| Vistanol ™ NPGC: | 15.00% |
| Candurin Paprika: | 0.50% |
| Montanox ™ 80: | 1.00% |
| Antaron ™ V216: | 0.90% |
| Apricot flavoring: | 0.20% |
| Sepicide ™ HB: | 0.50% |
| C Maltidex ™ H16322: | q.s. 100% |

### Example 52: Sun Soil Pressed Powder

| | |
|---|---|
| Polyelectrolyte 1: | 2.00% |
| Lanol ™ 99: | 12.00% |
| Sepiwhite ™ MSH: | 1.00% |
| Talc: | 33.00% |
| Micropearl ™ M310: | 3.00% |
| Yellow iron oxide: | 0.80% |
| Red iron oxide: | 0.30% |
| Black iron oxide: | 0.05% |
| Mica: | q.s. 100% |

### Example 53: Emulsion for Atopic-Prone Skin

| | |
|---|---|
| Arlacel ™ P135: | 2.00% |
| Polyelectrolyte 1: | 1.00% |
| Lanol ™ 1688: | 14.00% |
| Primol ™ 352: | 8.00% |
| Glycerol: | 5.00% |
| Water: | q.s. 100% |
| Magnesium sulfate: | 0.70% |
| Sepicide ™ HB: | 0.30% |
| Sepicide ™ CI: | 0.20% |
| Micropearl ™ M310: | 5.00% |

### Example 54: Soothing Antisun Care Product (Water-in-Silicone)

| | |
|---|---|
| Polyelectrolyte 1: | 2.00% |
| DC5225C: | 20.00% |
| DC345: | 10.00% |
| Sepicalm ™ VG: | 3.00% |
| Titanium dioxide MT100T: | 5.00% |
| Zinc oxide Z-cote HP1: | 5.00% |
| Sepicide ™ HB: | 0.30% |
| Fragrance: | 0.05% |
| Sepicide ™ CI: | 0.20% |
| Glycerol: | 5.00% |
| Sodium chloride: | 2.00% |
| Water: | q.s. 100% |

### Example 55: Multiphase Care Product

| | |
|---|---|
| Polyelectrolyte 1: | 3.00% |
| C12-15 alkyl benzoate: | 25.00% |
| Aquaxyl ™: | 3.00% |
| Sepitonic ™ M3: | 1.00% |
| Sepicide ™ HB: | 0.50% |
| Sepicide ™ CI: | 0.30% |

### Example 56: Self-Tanning Gel

| | |
|---|---|
| Polyelectrolyte 1: | 5.0% |
| Ethanol: | 30% |
| Dihydroxyacetone: | 5% |
| Menthol: | 0.1% |
| Caffeine: | 2.5% |
| Extract of Ivry: | 2% |
| Sepicide ™ HB: | 1% |
| Water: | q.s. 100% |

### Example 57: Antisun and Self-Tanning Gel

| | |
|---|---|
| Montanov ™ S: | 3.0% |
| Glyceryl triheptanoate: | 10.0% |
| Lipacide ™ PVB: | 1.05% |
| Polyelectrolyte 1: | 2.2% |
| Water: | q.s. 100% |
| Dihydroxyacetone: | 5% |
| Fragrance: | 0.1% |
| Sepicide ™ HB: | 0.3% |
| Sepicide ™ CI: | 0.1% |
| Parsol ™ MCX: | 4.0% |

### Example 58: Self-Tanning Cream with α-Hydroxy Acids

| | |
|---|---|
| Montanov ™ 68: | 5.0% |
| Lipacide ™ PVB: | 1.05% |
| Lanol ™ 99: | 10.0% |
| Water: | q.s. 100% |
| Gluconic acid: | 1.5% |
| Dihydroxyacetone: | 3% |
| Triethanolamine: | 0.9% |
| Polyelectrolyte 1: | 1.5% |
| Fragrance: | 0.4% |
| Sepicide ™ HB: | 0.2% |
| Sepicide ™ CI: | 0.4% |

### Example 59: Self-Tanning Cream with α-Hydroxy Acids for Sensitive Skin

| Mixture of N-lauroyl amino acids: | 0.1% to 5% |
|---|---|
| Magnesium potassium aspartate: | 0.002% to 0.5% |
| Montanov ™ 68: | 5.0% |
| Lanol ™ 99: | 2.0% |
| Water: | q.s. 100% |
| Lactic acid: | 1.5% |
| Dihydroxyacetone: | 3.5% |
| Triethanolamine: | 0.9% |
| Polyelectrolyte 1: | 1.5% |
| Fragrance: | 0.4% |
| Sepicide ™ HB: | 0.3% |
| Sepicide ™ CI: | 0.2% |

### Example 60: Self-Tanning, Moisturizing Satin Emulsion

| | |
|---|---|
| Simulsol ™ 165: | 5.0% |
| Lanol ™ 1688: | 8.5% |
| Galam butter: | 2% |
| Paraffin oil: | 6.5% |
| Lanol ™ 14M: | 3% |
| Lanol ™ S: | 0.6% |
| Water: | 66.2% |
| Dihydroxyacetone: | 3% |
| Micropearl ™ M 100: | 5% |
| Polyelectrolyte 1: | 3% |
| Aquaxyl ™: | 5% |
| Vitamin E acetate: | 0.20% |
| Sodium pyrrolidinonecarboxylate: | 0.20% |
| Fragrance: | 0.2% |
| Sepicide ™ HB: | 0.5% |
| Sepicide ™ CI: | 0.3% |

The definitions of the commercial products used in the examples are the following:

Simulsol™ 1293 is hydrogenated and ethoxylated castor oil, with an ethoxylation index equal to 40, sold by the company SEPPIC.
Capigel™ 98 is an acrylate copolymer-based liquid thickener sold by the company SEPPIC.
Ketrol™ T is xanthan gum sold by the company Kelco.
Lanol™ 99 is isononyl isononanoate sold by the company SEPPIC. DC1501 is a mixture of cyclopentasiloxane and dimethiconol sold by the company Dow Chemical.
Montanov™ 82 is an emulsifier based on cetearyl alcohol and cocoylglucoside.
Montanov™ 68 (cetearyl glucoside) is a self-emulsifiable composition as described in WO 92/06778, sold by the company SEPPIC.
Micropearl™ M 100 is an ultrafine powder with a very soft feel and a matting action, sold by the company Matsumo.
Sepicide™ Cl, imidazolidinyl urea, is a preservative sold by the company SEPPIC.
Pemulen™ TR1 is an acrylic polymer sold by Goodrich.
Simulsol™ 165 is self-emulsifiable glyceryl stearate sold by the company SEPPIC.
Lanol™ 1688 is an emollient ester with a nongreasy effect, sold by the company SEPPIC.
Lanol™ 14M and Lanol™ S are growth factors sold by the company SEPPIC.
Sepicide™ HB, which is a mixture of phenoxyethanol, methylparaben, ethylparaben, propylparaben and butylparaben, is a preservative sold by the company SEPPIC.

Aquaxyl™ is a moisturizer sold by the company SEPPIC.

Schercemol™ OP is an emollient ester with a nongreasy effect.
Lanol™ P is an additive with a stabilizing effect, sold by the company SEPPIC.
Parsol™ MCX is octyl para-methoxycinnamate sold by the company Givaudan.
Montanov™ S is a pearlescent agent, sold by the company SEPPIC, based on a mixture of alkyl polyglucosides such as those described in WO 95/13863.
Micropearl™ SQL is a mixture of microparticles containing squalane which is released by the action of massaging; it is sold by the company Matsumo.
Lanol™ 37T is glyceryl triheptanoate, sold by the company SEPPIC.
Solagum™ L is a carrageenan sold by the company SEPPIC.
Marcol™ 82 is a paraffin oil sold by the company Exxon.
Lanol™ 84D is dioctyl malate sold by the company SEPPIC.
Parsol™ NOX is a sunscreen sold by the company Givaudan.
Eusolex™ 4360 is a sunscreen sold by the company Merck.
Dow Corning™ 245 Fluid is cyclomethicone, sold by the company Dow Corning.
Lipacide™ PVB is an acylated wheat protein hydrolysate sold by the company SEPPIC.
Micropearl™ LM is a mixture of squalane, poly(methyl methacrylate) and menthol, sold by the company SEPPIC.
Sepicontrol™ A5 is a mixture of capryloyl glycine, sarcosine and extract of Cinnamon zylanicum, sold by the company SEPPIC, such as those described in international patent application PCT/FR98/01313 filed on Jun. 23, 1998.
Lanol™ 2681 is a mixture of coconut caprylate/caprate, sold by the company SEPPIC.
Montanov™ 202 is an APG/fatty alcohols composition as described in WO 98/47610, sold by the company SEPPIC.
Proteol™ APL is a foaming surfactant, sold by the company SEPPIC.
Schercemol™ TISC is an ester (triisostearyl citrate) sold by the company Scher.
Vistanol™ NPGC is an ester (neopentyl glycol dicaprate) sold by the company Sewa Kasei.
Antaron™ V216 is a synthetic polymer (PVP/hexadecene copolymer) distributed by the company Univar.
C Maltidex™ H16322 is a polyol (maltitol syrup) sold by the company Cerestar.
Sepiwhite™ MSH is a depigmenting agent (N-undecylenoyl phenylalanine) sold by the company SEPPIC.
DC 345 is a cyclomethicone sold by the company Dow Corning.
DC 5225C is a mixture of cyclopentasiloxane and dimethicone copolyol sold by the company Dow Corning.
Sepicalm™ VG is a soothing active agent (sodium palmitoyl proline) sold by the company SEPPIC.
MT100VT is a micronized titanium dioxide that has undergone a surface treatment (aluminum hydroxide/stearic acid), distributed by the company Unipex.
Z-Cote HP1 is a micronized zinc oxide that has undergone a surface treatment, distributed by Gattefosse.
Candurin Paprika is a mixture of potassium aluminum silicate and of iron oxide.
Micropearl™ M 310 is an ultrafine powder with a very soft feel and a matting action, sold by the company Matsumo.
PRIMOL™ 352 is a mineral oil sold by the company Exxon.
Pecosil™ DCT is sodium dimethicone PEG-7 acetyl methyltaurate sold by the company Phoenix.
Pecosil™ PS 100 is dimethicone PEG-7 sold by the company Phoenix.

1-16. (canceled)

17. A method for preparing a linear, branched or crosslinked anionic polyelectrolyte, characterized in that said anionic polyelectrolyte comprises, for 100 mol %, up to 95 mol % of monomer units derived from 2-methyl-2-[(1-oxo-2-propenyl)amino]-1-propanesulfonic acid that is totally salified in the form of the sodium salt, up to 90 mol % of at least one neutral monomer, and optionally up to 10 mol % of at least one monomer of formula (I): 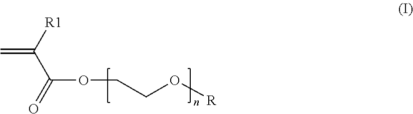
in which R1 is a hydrogen atom or a methyl radical, R is a linear or branched alkyl radical containing from eight to thirty carbon atoms, and n is a number greater than or equal to one and less than or equal to fifty, it being understood that the sum of the molar proportions of constituent monomer units of said anionic polyelectrolyte that are indicated above does not exceed 100 mol %, and in that said method comprises the following steps:
a step a) of preparing a reaction mixture containing, in the desired proportions and in a solvent (S), 2-methyl-2-[(1-oxo-2-propenyl)amino]-1-propanesulfonic acid, the neutral monomer(s), at least one neutralizing agent capable of forming the sodium salt of said 2-methyl-2-[(1-oxo-2-propenyl)amino]-1-propanesulfonic acid, if need be the monomer(s) of formula (I) as defined above, and, if necessary or if desired, crosslinking agent and/or other additives, said solvent (S) being:
either a ketone of formula (II): 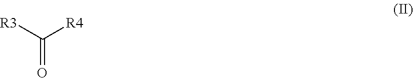
in which R3 and R4, which may be identical or different, are independently of one another a methyl radical, an ethyl radical, an isopropyl radical or an isobutyl radical;
or a mixture consisting of, for 100 mol %:
water in a proportion greater than 0 mol % and less than or equal to 25 mol %; and
a ketone of formula (II) as defined above, in a proportion greater than or equal to 75 mol % and less than 100 mol %;
a step b) during which the polymerization reaction is initiated by introducing, into said reaction mixture prepared in step a), a free-radical initiator and is then left to proceed to its conclusion, so as to obtain a precipitate of said linear, branched or crosslinked anionic polyelectrolyte.

18. The method as defined in claim 17, also comprising a step c) of isolating said precipitate obtained in step b) by separation from said solvent (S).

19. The method as defined in claim 18, also comprising a step d) of drying said precipitate resulting from step c).

20. The method as defined in claim 17, in which said solvent (S) is:
either a ketone selected from propan-2-one, butan-2-one, pentan-2-one, 3-methylbutan-2-one, 3-ethylpentan-20-one or 4-methylpentan-2-one;
or a mixture consisting of, for 100 mol %:
water in a proportion of greater than 0 mol % and less than or equal to 15 mol %, preferably less than or equal to 5 mol %; and
a ketone selected from propan-2-one, butan-2-one, pentan-2-one, 3-methylbutan-2-one, 3-ethylpentan-2-one or 4-methylpentan-2-one, of formula (II) as defined above, in a molar proportion of greater than or equal to 90 mol %, preferably greater than or equal to 95 mol % and less than 100 mol %.

21. The method as defined in claim 20, in which said solvent (S) is either acetone, or a water/acetone mixture in a water/acetone molar ratio of greater than 0 and less than or equal to 5/95.

22. The method as defined in claim 17, characterized in that said anionic polyelectrolyte comprises, for 100 mol %, between 0.05 mol % and 5 mol %, and more particularly between 0.1 mol % and 1 mol %, of monomer units derived from a compound of formula (I).

23. The method as defined in claim 17, characterized in that said anionic polyelectrolyte comprises monomer units derived from a neutral monomer selected from acrylamide, (2-hydroxyethyl) acrylate or N,N-dimethylacrylamide.

24. The method as defined in claim 17, characterized in that said anionic polyelectrolyte comprises, for 100 mol %, more than 10 mol %, preferably more than 25 mol % and up to 90 mol % of monomer units derived from 2-methyl-2-[(1-oxo-2-propenyl)amino]-1-propanesulfonic acid that is totally salified in the form of the sodium salt, from 5 mol % up to less than 90 mol %, preferably up to less than 75 mol %, of a neutral monomer, and from 0 mol % to 5 mol% of a monomer of formula (I).

25. The method as defined in claim 24, characterized in that said anionic polyelectrolyte comprises, for 100 mol %, more than 50 mol %, preferably more than 75 mol %, and up to 85 mol % of monomer units derived from 2-methyl-2-[(1-oxo-2-propenyl)amino]-1-propanesulfonic acid that is totally salified in the form of the sodium salt, from 10 mol % and up to less than 50 mol %, preferably less than 25 mol %, of a neutral monomer, and from 0 mol % to 5 mol % of a monomer of formula (I).

26. The method as defined in claim 17, characterized in that said anionic polyelectrolyte is crosslinked and/or branched with a diethylene or polyethylene compound in the molar proportion, expressed relative to all the monomers used, of between 0.005 mol % and 1 mol %.

27. A variant of the method as defined in claim 17, characterized in that it comprises, in place of step a), a step a2) of preparing a reaction mixture comprising, in the desired proportions and in a solvent (S), the neutral monomer(s), the sodium salt of said 2-methyl-2-[(1-oxo-2-propenyl)amino]-1-propanesulfonic acid, and if need be the monomer(s) of formula (I) as defined above.

28. The variant of the method as defined in claim 27, characterized in that it comprises, prior to step a2), a step a1) of preparing the sodium salt of 2-methyl-2-[(1-oxo-2-propenyl)amino]-1-propanesulfonic acid by neutralizing said 2-methyl-2-[(1-oxo-2-propenyl)amino]-1-propanesulfonic acid with a neutralizing agent capable of forming the sodium salt of said 2-methyl-2-[(1-oxo-2-propenyl)amino]-1-propanesulfonic acid.

29. The method or the variant thereof as defined in claim 17, characterized in that said crosslinked anionic polyelectrolyte is a crosslinked terpolymer of 2-methyl-2-[(1-oxo-2-propenyl)amino]-1-propanesulfonic acid that is salified in the form of the sodium salt, of N,N-dimethylacrylamide and of pentacosaethoxylated behenyl methacrylate, in which, for 100% of monomer units, more than 75 mol % and up to 85 mol % of monomer units are derived from 2-methyl-2-[(1-oxo-2-propenyl)amino]-1-propanesulfonic acid that is totally salified in the form of the sodium salt, from 10 mol % up to less than 25 mol % from a neutral monomer, and 0.05 mol % and 5 mol % from a monomer of formula (I).
